(19) United States
(12) Patent Application Publication
(10) Pub. No.: US 2019/0020033 A1
(43) Pub. Date: Jan. 17, 2019

(54) IONOMER ELECTRODE MANUFACTURING SLURRY

(71) Applicant: Lionano Inc., Woburn, MA (US)

(72) Inventors: Minghui Li, Ithaca, NY (US); Peishen Huang, Ithaca, NY (US); Yun Shen, Changshu (CN); Yingchao Yu, Cambridge, MA (US)

(73) Assignee: Lionano Inc., Woburn, MA (US)

(21) Appl. No.: 16/037,041

(22) Filed: Jul. 17, 2018

Related U.S. Application Data
(60) Provisional application No. 62/533,652, filed on Jul. 17, 2017.

(51) Int. Cl. H01M 4/62; H01M 10/0525; H01M 4/04; H01M 4/13; C09D 5/24; C09D 127/20; C09D 127/16; C09D 143/00; C09D 133/02

(52) U.S. Cl. CPC H01M 4/62; H01M 10/0525; H01M 4/0404; H01M 4/0471; C09D 133/02; C09D 5/24; C09D 127/20; C09D 127/16; C09D 143/00; H01M 4/13

(57) ABSTRACT

The present invention generally relates to materials for electrochemical cells, e.g., for use in batteries such as lithium-ion batteries, and other applications. For example, certain embodiments of the present invention provide a composition for a slurry or a slurry for the manufacture of an electrode for an electrochemical cell. The slurry, in certain embodiments, comprises a combination of ionomer, binder, conducting additive, electroactive materials, and water. The ionomer, in some embodiments, includes a polymer backbone, one or more anionic substituents (which may be in the backbone and/or in one or more pendant groups), and one or more cations.

### RELATED APPLICATIONS

This application claims the benefit of U.S. Provisional Patent Application Ser. No. 62/533,652, filed Jul. 17, 2017, entitled “Ionomer Electrode Manufacturing Slurry,” by Minghui Li, et al., which is incorporated herein by reference in its entirety.

### FIELD

The present invention generally relates to materials and methods for electrochemical cells, e.g., for use in batteries such as lithium-ion batteries, and other applications.

### BACKGROUND

Currently, battery electrode manufacturing entails dissolving conventional lithium-ion binders (e.g. polyvinylidene fluoride (PVDF)) with organic solvents, homogenizing the solution with a powdery electrode material and conductive additives, then applying this slurry to a metal current collector, e.g. aluminum or copper. The organic solvent serves to bind the powdery electrode particles to each other and to the current collector as the solvent evaporates. Most widely used electrode materials (e.g. lithium cobalt oxide, lithium nickel manganese cobalt oxide, lithium nickel cobalt aluminum oxide, and carbon-based anodes) are not stable in an aqueous environment, necessitating the use of organic solvents, which are toxic and flammable. In the battery industry, the most commonly used organic solvent is N-methyl pyrrolidone (NMP).

NMP is highly hazardous, can easily be absorbed through the skin, and will irritate the eyes, skin, nose, and throat upon exposure. Toxicology studies show that NMP damages the reproductive system of male and female test animals, and pregnant animals exposed to NMP exhibit abnormal fetal development. Long-term overexposure to NMP affects the central nervous system, and causes symptoms such as fatigue, sleeplessness, poor coordination, difficulty concentrating, loss of short-term memory, and mental/personality disorders such as depression, anxiety, and irritability. The European Chemicals Agency has assessed NMP's health-risk classification as “very high concern” due to its carcinogenic and mutagenic properties. California's Department of Public Health has revised the Health Hazard Advisory guidelines to set a Permissible Exposure Limit for those working with NMP. As an organic solvent, NMP is flammable with a flash point at 95° C., making it a fire hazard during manufacturing. Given the environmental and safety concerns associated with the use of NMP, techniques that avoid the use of organic solvents are urgently required.

Water-based techniques have been proposed as an alternative to the steps involving NMP in electrode manufacturing. Water is considered the most promising solvent candidate because it is environmentally friendly and extremely cheap. Replacing expensive NMP with deionized water would significantly reduce the cost of electrode manufacturing in terms of both materials and overhead, as fewer safety precautions are needed when manufacturing with an aqueous system.

Using water as a solvent/dispersant can decrease production cost and significantly improve manufacturing safety in regards to flammability, environmental impact, and human health. However, implementation of aqueous processing for electrode production has been hindered by uncertainty about how to disperse the materials successfully in water. Aqueous processing introduces several problems, such as agglomeration, due to strong interactions between particles, and inferior wetting of the cathode dispersion onto the aluminum current collector. Methods using emulsifier and water-soluble polymer binders have been suggested, but are not successful in execution. Emulsifier cannot be removed after drying and can reduce the electrical conductivity of cathode material, resulting in lower energy capacity and destabilized cycling performance. A water-soluble polymer containing hydroxy or carboxylic acid can change the pH of the slurry during processing, which can disrupt the uniformity of the cathode slurry. Accordingly, improvements in manufacturing techniques and the like are needed.

### SUMMARY

The present invention generally relates to materials and methods for electrochemical cells, e.g., for use in batteries such as lithium-ion batteries, and other applications. The subject matter of the present invention involves, in some cases, interrelated products, alternative solutions to a particular problem, and/or a plurality of different uses of one or more systems and/or articles.

In some aspects, the present invention generally provides a composition for a slurry, or a slurry for the manufacture of an electrode for an electrochemical cell. For example, certain embodiments provide a slurry comprised of a combination of: x % of ionomer, y % of a mixture of binder and conducting additive in a molar ratio of a/(1−a), where a is a numerical value ranging from 0 to 1 (0<a<1), and (100−x−y) % of electroactive materials in an aqueous solution, where x %, y %, and (100−x−y) % are all weight percentages. In some embodiments, the ionomer-controlled binder can be used in a water-based slurry, which may allow for easier handling, reduced environmental pollution, and/or reduced production costs, while maintaining the chemical and electrochemical advantages of a binder, conducting additives, and electroactive materials.

In some embodiments, a is a numerical value ranging from 0 to 1 (0<a<1), x is a numerical value inclusively ranging from 0.01 to 49.99, y is a numerical value inclusively ranging from 0.01 to 49.99, and 100−x−y is greater than 0.

In certain embodiments, the aqueous solution is deionized water. The composition of the slurry may not necessarily require organic solvents, but such solvents could be used in some embodiments. The slurries may be free of any organic solvent and the expensive, restrictive. Complicated handling of organic solvents may be avoided or reduced during the manufacture of a slurry in some cases. In many cases, there may be a water-free effective electroactive material before electrolyte is added. The slurry or the manufactured electrode may therefore be dried in some embodiments.

In another aspect, the present invention encompasses methods of, or the manufacture of, an electrode for an electrochemical cell. The method may in some cases comprise making a slurry comprising a combination of x % of ionomer, y % of a mixture of binder and conducting additive in a molar ratio of a/(1−a), where a is a numerical value ranging from 0 to 1 (0<a<1), and (100−x−y) % of electroactive materials in an aqueous solution, where x %, y % and (100−x−y) % are all weight percentages. In some embodiments, x is a numerical value inclusively ranging from 0.01 to 49.99, y is a numerical value inclusively ranging from 0.01 to 49.99, a is a numerical value ranging from 0 to 1 (0<a<1), and 100−x−y is greater than 0. In addition, some embodiments are directed to methods of coating or laminating the slurry on a current collector, and drying the slurry. Some methods may further comprise adding a non-aqueous electrolyte to the electrode.

In one aspect, the present invention is generally directed to a composition. In one set of embodiments, the composition comprises an ionomer, a binder, a conductive additive, and an electroactive material. The composition, in another set of embodiments, comprises an aqueous slurry comprising less than 50 wt % of an ionomer, less than 50 wt % of a binder and a conductive additive, and an electroactive material.

In another aspect, the present invention is generally directed to a method of making an electrode for use in an electrochemical cell. The method, in one set of embodiments, comprises applying, to a current collector material, an aqueous slurry comprising an ionomer, a binder, a conductive additive, and an electroactive material. The method may also include removing at least some water from the aqueous slurry to produce a dried coating on the current collector material. In another set of embodiments, the method comprises applying, to a current collector material, an aqueous slurry comprising less than 50 wt % of an ionomer, less than 50 wt % of a binder and a conductive additive, and an electroactive material; and removing at least some water from the aqueous slurry to produce a dried coating on the current collector material.

According to yet another aspect, the present invention is generally directed to an electrochemical device. In one set of embodiments, the electrochemical device comprises an electrode formed using a method comprising applying, to a current collector material, an aqueous slurry comprising less than 50 wt % of an ionomer, less than 50 wt % of a binder and a conductive additive, and an electroactive material; and removing at least some water from the aqueous slurry to produce a dried coating on the current collector material, thereby forming an electrode. In some cases, the electrochemical device comprises an electrode formed using a method comprising applying, to a current collector material, an aqueous slurry comprising an ionomer, a binder, a conductive additive, and an electroactive material. The method may also include, in some cases, removing at least some water from the aqueous slurry to produce a dried coating on the current collector material, thereby forming the electrode.

In another aspect, the present invention encompasses methods of making one or more of the embodiments described herein, for example, a slurry. In still another aspect, the present invention encompasses methods of using one or more of the embodiments described herein, for example, a slurry.

Other advantages and novel features of the present invention will become apparent from the following detailed description of various non-limiting embodiments of the invention when considered in conjunction with the accompanying figures.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a plot of the first cycle voltage vs capacity for an electrochemical cell prepared with the positive electroactive material produced with an embodiment of the present invention;

FIG. 2 is a plot of the discharge capacity versus the cycling number for an electrochemical cell prepared with the positive electroactive material produced with another embodiment of the present invention;

FIGS. 3A-3B illustrate NMR spectra of PLA obtained from a cathode electrode produced with yet another embodiment of the present invention; and

FIGS. 4A-4G illustrate non-limiting examples of ionomers useful in certain embodiments of the present invention.

### DETAILED DESCRIPTION

The present invention generally relates to materials for electrochemical cells, e.g., for use in batteries such as lithium-ion batteries, and other applications. For example, certain embodiments of the present invention provide a composition for a slurry or a slurry for the manufacture of an electrode for an electrochemical cell. The slurry, in certain embodiments, comprises a combination of ionomer, binder, conducting additive, electroactive materials, and water. The ionomer, in some embodiments, includes a polymer backbone, one or more anionic substituents (which may be in the backbone and/or in one or more pendant groups), and one or more cations.

In some embodiments, an electrochemical cell may be produced using a material as described herein. Slurries may be used for manufacturing positive or negative electrodes, i.e. cathodes or anodes. The slurry may be coated onto a current collector. The current collector can be a metal foil and can comprise materials such as copper or aluminum, but other current collectors can also be used. For example, a lithium-ion electrochemical cell may be prepared using a cathode comprising a positive electroactive material such as described herein, an anode comprising a negative electroactive material such as described herein, a suitable electrolyte (e.g., a non-aqueous electrolyte), and a separator between the negative electroactive material and the positive electroactive material. A slurry, according to some embodiments of the present invention, is prepared by mixing a binder, an ionomer, a conductive additive, and an electroactive material to form an aqueous solution. Further components may be added to the slurry in some cases.

Ionomers have not previously been suggested for use in aqueous slurries, e.g., for the production of batteries or other electrochemical cells. Ionomers used for electrode preparations have not used water (or other aqueous solutions) as a solvent. An aqueous slurry thus may include an ionomer and water (or another suitable aqueous solution, e.g., as discussed herein) as a solvent, as well as other components such as a binder, a conductive, and/or an electroactive material. Without wishing to be bound by any theory, it is believed that ionomers dissolved in water may allowed enhanced performance for the electrode. In addition, the use of water may facilitate the formation of an electrode, e.g., as composed to hazardous organic solvents such as N-methyl pyrrolidone (NMP).

Ionomers generally include polymers containing repeating charged subunits (although all of the subunits within an ionomer may not necessarily be charged). The charged subunits may be present on the backbone and/or pendant groups within the ionomer. As discussed below, in some cases an ionomer may include one or more subunits that may be charged, e.g., at pH's typically present within batteries or other electrochemical cells (for example, pH's of at least 3, at least 5, at least 7, at least 9, at least 11, and/or no more than 13, more than 11, no more than 9, no more than 7, no more than 5, and/or combinations thereof). Some types of ionomers can be obtained commercially.

Examples of suitable subunits within a ionomer include vinylsulfonate, methacrylic acid, and other subunits such as those discussed herein. Additional examples of subunits that may be present in an ionomer include, but are not limited to, substituents containing carboxylate and sulfonate anions. Specific non-limiting examples include fluoroalkyl sulfonate, phenyl sulfonate, trifluoromethylsulfonylimide, 4-phenylsulfonylimide, and bis(allylmalonato)borate.

In one set of embodiments, the subunits may be organic anions, with negative charges on the oxygen or nitrogen that covalently bonded on sulfur, nitrogen or carbon. These subunits may be covalently attached on polymer backbone, e.g., as grafted side units and/or as chain ends on polymer backbone.

In some cases, at least 2 mol %, at least 4 mol %, at least 6 mol %, at least 8 mol %, at least 10 mol %, at least 12 mol %, at least 14 mol %, at least 16 mol %, at least 18 mol %, or at least 20 mol % of a ionomer are charged subunits, e.g., anionic substituents. In addition, in some embodiments, no more than 20 mol %, no more than 18 mol %, no more than 16 mol %, no more than 14 mol %, no more than 12 mol %, no more than 10 mol %, no more than 8 mol %, no more than 6 mol %, no more than 4 mol %, or no more than 2 mol % of the ionomer comprises charged subunits. Combinations of these are also possible, e.g., an ionomer may have between 12 mol % and 20 mol % of charged subunits.

In certain embodiments, the ionomer may contain a polymer backbone, one or more anionic substituents (which may be in the backbone and/or in pendant groups), and one or more cations, e.g., countering the anions in solution. In some cases, at least 90 wt % of the ionomer includes the polymer (including the backbone and anionic substituents) and cations, and in some cases, at least 91 wt %, at least 92 wt %, at least 93% wt %, at least 94 wt %, at least 95 wt %, at least 96 wt %, at least 97 wt %, at least 98 wt %, at least 99 wt %, or 100% of the ionomer comprises the polymer (including the backbone and anionic substituents), and cations. In some cases, the ionomer may also contain other impurities, preservatives, additives, or the like.

In some cases, the molar ratio of the anionic substituents and cations within the ionomer may be substantially equal to one, for example, when the anionic substituents and the cations have approximately the same charge with opposite sign (e.g., +1 and −1), such that the ionomer is overall electroneutral in charge. For example, the molar ratio may be between 0.9:1 and 1.1:1, or between 0.95:1 and 1.05:1.

In some embodiments, the molar ratios of the anionic substituents and the cations within the ionomer may be substantially the same, e.g., equal, or within a few mole percent of each other relative to the ionomer (e.g., having a difference of less than 10 mol %, less than 9 mol %, less than 8 mol %, less than 7 mol %, less than 6 mol %, less than 5 mol %, less than 4 mol %, less than 3 mol %, less than 2 mol %, less than 1 mol %, relative to their overall molar percentages within the ionomer.

However, in other embodiments, the molar ratio of the anionic substituents and cations may not necessarily be substantially equal to one, for example, when the anionic substituents and the cations have different absolute charges. For instance, an anion may have a −1 charge while a cation may have a +2 charge, such that the molar ratio between the anions and the cations may be about 2:1 (e.g., such that the molar ratio between charges is about 1:1, thereby maintaining electroneutrality).

Thus, for example, the molar ratios between the anionic substituents and the cations (or between the cations and the anionic substituents) may, in some embodiments, be about 2:1 (e.g., between 1.95:1 and 2.05 to 1, between 1.9:1 and 2.1:1, etc.), about 3:1 (e.g., between 2.95:1 and 3.05 to 1, between 2.9:1 and 3.1:1, etc.), about 4:1 (e.g., between 3.95:1 and 4.05 to 1, between 3.9:1 and 4.1:1, etc.), about 3:2 (e.g., between 2.95:2 and 3.05 to 2, between 2.9:2 and 3.1:2, etc.), or the like.

Without wishing to be bound by any theory, the mole ratio may be controlled such that the overall molar amounts of the negative charges carried by anionic substituents and the positive charges carried by cations may be substantially the same within the ionomer in certain embodiments, e.g., to maintain electroneutrality of the ionomer. It should be understood, however, that by using different cations with different charges, the weight ratios of the anionic substituents and the cations within the ionomer may be the same or different. As a non-limiting example, an ionomer may have between 15 wt % and 60 wt % anionic substituents and less than 5 wt % cations, while still maintaining electroneutrality due to the overall charges on each.

The ionomer may contain +1 charged cations, and/or more highly charged cations (which may result in a smaller overall weight percentage of cations in the ionomer to maintain electroneutrality). Non-limiting examples of more highly charged cations include +2 charge (Mg²⁺, Ca²⁺, Fe²⁺, etc.), +3 charge (Fe³⁺, Al³⁺, etc.), +4 charge (V⁴⁺, etc.), or the like. Thus, by using suitably highly charged cations, the overall charge of the cations may be substantially the same as the overall charge of the anionic substituents in the ionomer, even if they have different weight percentages. In addition, a plurality of cations having varying masses and/or charges may be used in certain embodiments to produce a desired cation weight within the ionomer.

In one embodiment, as a non-limiting example, if 100% of the ionomer is polymer, anion, or cation, and q % of the ionomer is polymer, then (1−q)/2% of the ionomer may be anions and (1−q)/2% may be cations, where q % and (1−q)/2% are all weight percentages, and q and (1−q)/2 are greater than 0. In some cases, q may be greater than (1−q)/2. However, in other embodiments, these percentages may differ (for example, the anions and the cations may not have exactly the same weight percentage, these percentages may not necessarily add to 100% because of impurities, or the like).

In some cases, the polymer backbone may be present within the ionomer at at least 10 wt %, at least 20 wt %, at least 30%, at least 40 wt %, at least 50 wt %, at least 55 wt %, at least 60 wt %, at least 65 wt %, at least 70 wt %, at least 75 wt %, at least 80 wt %, at least 85 wt %, at least 90 wt %, or at least 95 wt %. In some cases, the polymer may be present within the ionomer at no more than 95 wt %, no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 40 wt %, no more than 30 wt %, or no more than 20 wt %. Combinations of any of these are also possible; for example, the polymer backbone may form between 50 wt % and 60 wt % of the ionomer, or between 10 wt % and 80 wt %.

Non-limiting examples of ionomer structures include homopolymers (1 polymer segment or type of repeat unit within the backbone), copolymers (2 polymer segments), terpolymers (3 polymer segments), tetrapolymers (4 polymer segments), or other higher-order polymers. If more than one type of polymer subunit is present, the polymer segments forming the ionomer may be arranged in any suitable order, e.g., as random, block, alternating, graft, or the like. Examples of specific polymer segments that may be within the polymer include, but are not limited to, styrene, ethylene, propylene, acrylate, methacrylate, methacrylic acid, butadiene, vinylidene difluoride, tetrafluoroethylene, and combinations of these and/or other groups. Additional non-limiting examples of polymer segments include perfluoroether, ethylene terephthalate, carbonate, urethane, urea, benzimidazole, lactic acid, acrylonitrile, amide, ethylene terephthalate, caprolactone. These may, for example, be polymerized to define one or more backbone groups or repeat units within the polymer backbone. Thus, as one example, the ionomer comprises poly(lithium acrylate). Additional examples of polymer backbones include, but are not limited to, perfluoropolyether, polyethylene terephthalate, polycarbonate, polyurethane, polyurea, polybenzimidazole, polylactic acid, polyacrylonitrile, polyamide, polyethylene terephthalate, polycaprolactone, and the like.

The ionomer may also include one or more anionic substituents (acting as anions to the cations) and/or one or more cations. In some cases, the anion-cation pairings may be present at at least 5 wt %, at least 10 wt %, at least 15 wt %, at least 20 wt %, at least 25 wt %, at least 30 wt %, at least 35 wt %, at least 40 wt %, or at least 45 wt % of the ionomer. In some cases, the anion-cation pairings may be present no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, or no more than 5 wt % of the ionomer. Combinations of any of these are also possible; for example, the anion-cation pairings may form between 40 wt % and 50 wt % of the ionomer.

Non-limiting examples of anionic substituents that may be used within the ionomer include carboxylates, alkyl carboxylates (e.g., methyl carboxylate, ethyl carboxylate, etc.), perfluoro alkyl carboxylates (e.g., perfluoromethyl carboxylate, perfluoroethyl carboxylate, etc.), thioglycolates, phosphonates, sulfonates, vinylsulfonates, borates, benzenesulfonates, tartrates, and combinations of these and/or other anions. Specific non-limiting examples include fluoroalkyl sulfonate, phenyl sulfonate, trifluoromethylsulfonylimide, 4-phenylsulfonylimide, and bis(allylmalonato)borate, etc. These may be present, for example, as repeat units within the backbone and/or within pendant groups within the ionomer.

In some cases, the anionic substituents may be present within the ionomer at at least 10 wt %, at least 15 wt %, at least 20 wt %, at least 25 wt %, at least 30%, at least 35 wt %, at least 40 wt %, at least 45 wt %, at least 50 wt %, at least 55 wt %, at least 60 wt %, at least 65 wt %, at least 70 wt %, at least 75 wt %, etc. In some cases, the anionic substituents may be present within the ionomer at no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, or no more than 15 wt %, etc. Combinations of any of these are also possible; for example, the anionic substituents may form between 15 and 60 wt % of the ionomer.

It should also be understood that in some cases, one or more free anions may also be present within the ionomer. Non-limiting examples include fluoride (F⁻), chloride (Cl⁻), sulfate (SO₄²⁻), or the like.

Non-limiting examples of cations that may be present in the ionomer include sodium, potassium, lithium, magnesium, calcium, aluminum, zinc, iron, copper, silver, cobalt, mercury, nickel, chromium, and combinations of these and/or other cations.

As mentioned, in some cases, the cations may be present at a weight percentage that is the same, or different, than the anionic substituents. In certain embodiments, the cations are present at an amount that substantially neutralizes the anionic substituents, e.g., such that the ionomer is electroneutral. In some cases, the cations may be present at a weight percentage of no more than 30 wt %, no more than 25 wt %, no more than 20 wt %, or no more than 15 wt %, no more than 10 wt %, or no more than 5 wt %. In some embodiments, the cations are present at at least 1 wt %, at least 5 wt %, at least 10 wt %, at least 15 wt %, at least 20 wt %, at least 25 wt %, at least 30%, etc. Combinations of any of these are also possible; for example, the cations may form between 1 wt % and 5 wt % of the ionomer.

The anion-cation pair used in an ionomer may include any combination of one or more anion substituents and one or more cations. Thus, specific non-limiting examples of anion-cation pairs that may be used include sodium carboxylate, sodium methyl carboxylate, potassium perfluoromethyl carboxylate, sodium perfluoromethyl carboxylate, lithium perfluoromethyl carboxylate etc. In some cases, as mentioned, more than one anion-cation pair may be present in an ionomer; for example, an ionomer may comprise lithium thioglycolate and magnesium phosphonate, calcium benzesulfonate and calcium tartrate, etc.

In some cases, the ionomer may have a molecular weight (Mₙ) of at least 100 Da, and in some cases, at least 300 Da, at least 500 Da, at least 1,000 Da, at least 3,000 Da, at least 5,000 Da, at least 10,000 Da, at least 30,000 Da, at least 50,000 Da, at least 100,000 Da, at least 300,000 Da, at least 500,000 Da, at least 1,000,000 Da, at least 3,000,000 Da, at least 5,000,000 Da, at least 10,000,000 Da, etc. In some cases, the ionomer may have a molecular weight of less than 10,000,000 Da, less than 5,000,000 Da, less than 3,000,000 Da, less than 1,000,000 Da, less than 500,000 Da, less than 300,000 Da, less than 100,000 Da, less than 50,000 Da, less than 30,000 Da, less than 10,000 Da, less than 5,000 Da, less than 3,000 Da, less than 1,000 Da, less than 500 Da, less than 300 Da, etc. Combinations of any of these are also possible; for example, the molecular weight may be between 100 Da and 5,000 Da.

Specific non-limiting examples of ionomers include those shown in FIGS. 4A-4G. In these examples, n and m may be any suitable positive integer, e.g., such that the ionomer has the molecular weights described herein. In some cases n and m are equal although in other cases, they may be different. As discussed herein, the subunits may be arranged in any suitable order, e.g., as random, block, alternating, or the like.

In one set of embodiments, the ionomer comprises lithium cations, such as those shown in FIGS. 4A-4G. However, it will be appreciated that although these examples all use Li⁺ as a cation, this is by way of example only, and that in other embodiments, other cations can be used, in addition to or instead of Li⁺, including those anions discussed herein.

In certain embodiments, the ionomer is a polymer comprising ethylene subunits and one or more anionic substituents within the backbone of the polymer. The ethylene subunits and the anionic substituents may be arranged within the polymer in any suitable order, e.g., as random, block, alternating, or the like. Non-limiting examples of such ionomers include those shown in FIGS. 4A-4G. However, it should be understood that although these examples all use ethylene (polyethylene, —(CH₂—CH₂)—) as groups forming the polymer backbone, this is by way of example only, and that in other embodiments, other groups can be used, in addition to or instead of ethylene, including any of those discussed herein. It will also be noted that in these examples, the anionic substituents are present within the backbone, although in other embodiments, the anionic substituents may be present in one or more pendant groups, in addition to or instead of the backbone.

As mentioned, a slurry, in some aspects, may include a binder, an ionomer, and a conductive additive, an electroactive material, and water. In one set of embodiments, a slurry may contain less than 10 wt % binder, less than 10 wt % ionomer, less than 10% conductive additive, and between 50 wt % and 80 wt % electroactive material. In other embodiments, the slurry may include any of the weight percentages of each of these components as described in detail below.

Without wishing to be bound by any theory, it is believed that the use of aqueous slurries, e.g., to form electrodes, may be a useful and less hazardous process than other processes that use organic solvents such as N-methyl pyrrolidone. The components of the electrodes can thus be formed together (for example, insoluble particles such as PVDF, and/or polymers with similar binding properties, insoluble inorganic particles such as carbon black particles, etc.) without the use of organic solvents.

In some cases, water may act as a solvent while the ionomer acts as a solute. In some cases, the water used as a solvent may also contain a variety of other solutes to form a solution, for example, various salts (e.g., cations for the ionomer). In addition, the aqueous solution may have different pH's, e.g., being acidic (less than pH 7, less then pH 6, less than pH 5, etc.), alkaline (greater than pH 7, greater than pH 8, greater than pH 9, etc.), or being neutral (e.g., having a pH of between 5 and 9, between 6 and 8, etc.).

The ionomer (including one or more polymers and/or one or more anions and/or one or more cations) may be present within a slurry at any suitable concentration or amount. In some cases, for example, the ionomer may comprise 50 wt % or less, 45 wt % or less, 40 wt % or less, 35 wt % or less, 30 wt % or less, 25 wt % or less, 20 wt % or less, 15 wt % or less, 12 wt % or less, 10 wt % or less, 8 wt % or less, 6 wt % or less, 5 wt % or less, 4 wt % or less, 3 wt % or less, or 2 wt % or less of the slurry as it is formed. In addition, in some cases, the ionomer is present at at least 0.01 wt %, at least 0.1 wt %, or at least 1 wt %.

In certain embodiments, the binder, when present, may comprise polyvinylidene fluoride (PVDF), poly-o-methoxyaniline (POMA), Polytetrafluoroethylene (PTFE), poly(vinylidene fluoride-hexafluoropropylene) (PVDF-HFP), polyethylene oxide (PEO), and/or poly(3,4-ethylenedioxythiophene) polystyrene sulfonate (PEDOT:PSS), as well as combinations of these and/or other binders. The binder may be present at any suitable concentration or amount. In some cases, for example, the binder may comprise 50 wt % or less, 45 wt % or less, 40 wt % or less, 35 wt % or less, 30 wt % or less, 25 wt % or less, 20 wt % or less, 15 wt % or less, 12 wt % or less, 10 wt % or less, 8 wt % or less, 6 wt % or less, 5 wt % or less, 4 wt % or less, 3 wt % or less, or 2 wt % or less of the slurry as it is formed. In addition, in some cases, the binder is present at at least 0.01 wt %, at least 0.1 wt %, or at least 1 wt %. Without wishing to be bound by any theory, the binder may facilitate mechanical integrity of the electrodes formed from the slurry.

In certain embodiments, the conducting additive, when present, may comprise carbon black, poly(3,4-ethylenedioxythiophene) polystyrene sulfonate (PEDOT:PSS), carbon nanotubes, carbon nanofibers, polypyrrole, graphene, and/or graphene oxide, as well as combinations of these and/or other conductive additives. The conductive additive may be present at any suitable concentration or amount. In some cases, for example, the conductive additive may comprise 50 wt % or less, 45 wt % or less, 40 wt % or less, 35 wt % or less, 30 wt % or less, 25 wt % or less, 20 wt % or less, 15 wt % or less, 12 wt % or less, 10 wt % or less, 8 wt % or less, 6 wt % or less, 5 wt % or less, 4 wt % or less, 3 wt % or less, or 2 wt % or less of the slurry as it is formed. In addition, in some cases, the conductive additive is present at at least 0.01 wt %, at least 0.1 wt %, or at least 1 wt %. Without wishing to be bound by any theory, the conductive additive may reduce electrical resistance within the electrode, or promote higher energy density or cycle life.

In addition, in some cases, the combination of binder and conductive additive may comprise 50 wt % or less, 45 wt % or less, 40 wt % or less, 35 wt % or less, 30 wt % or less, 25 wt % or less, 20 wt % or less, 15 wt % or less, 12 wt % or less, 10 wt % or less, 8 wt % or less, 6 wt % or less, 5 wt % or less, 4 wt % or less, 3 wt % or less, or 2 wt % or less of the slurry as it is formed.

The electroactive material may include, for example, graphite, lithium titanate, metallic lithium, and/or lithium metal oxides (e.g. lithium manganese oxide, lithium nickel cobalt aluminum oxide, lithium cobalt oxide, lithium nickel cobalt manganese oxide, lithium iron phosphate and/or other metal oxides and/or their blends), as well as combinations of these and/or other electroactive materials. Similarly, a variety of negative electroactive materials may be used, many of which can be obtained commercially. For example, graphite or lithium foil may be used in the electrochemical cell as a lithium intercalation negative electroactive material.

The electroactive material may be present at any suitable concentration or amount. In some cases, for example, the electroactive material may comprise at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, or at least 95 wt % or more of the slurry as it is formed. In some cases, the conductive additive may comprise no more than 99 wt %, no more than 95 wt %, no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, or no more than 10 wt % of the slurry. Combinations of any of these are also possible; for example, the slurry may comprise between 70 wt % and 90 wt % of electroactive material.

As mentioned, the slurry may contain water, which may be pure (e.g., distilled) or contain other components, such as salts, impurities, preservatives, additives, or the like. In some cases, the slurry may contain at least 5 wt %, at least 10 wt %, at least 15 wt %, at least 20 wt %, and/or 25 wt % or less, 20 wt % or less, 15 wt % or less, 12 wt % or less, 10 wt % or less, 8 wt % or less, 6 wt % or less, 5 wt % or less of water.

In some embodiments, a slurry may be formed into an electrode, e.g., for use in a battery or other electrochemical cell. For example, in one aspect, an aqueous solution containing a binder, an ionomer, and a conductive additive, and an electroactive material may be prepared. The binder, ionomer, conductive additive, and electroactive material may each be present within the aqueous solution in any of the amounts or percentages (e.g., weight percentages) described herein. In some embodiments, these may be present in such amounts or concentrations that the aqueous solution has a viscosity greater than that of water, e.g., the aqueous solution becomes a slurry.

In some cases, a slurry may be prepared by mixing a binder, an ionomer, a conductive additive with an electroactive material in an aqueous solution. For example, an ionomer may be dissolved in water. Then a binder, an electroactive material, and a conductive additive may be mixed in, in any suitable combination (e.g., serially and/or simultaneously), and the aqueous slurry may be spread onto a current collector to form an electrode. Thus, a slurry may contain an ionomer, a binder, a conductive additive, and an electroactive material. The slurry may be used to prepare positive electrodes and/or negative electrodes.

Without wishing to be bound by any theory, it is believed that in certain embodiments, uses of slurries such as those described herein may reduce or eliminate the use of hazardous or expensive organic solvents, such as N-methyl pyrrolidone, N-vinyl pyrrolidone, or 1,3-dimethyl-2-imidazolidinone. Such organic solvents are typically used due to the difficulty of solubilizing polymers, e.g., during the preparation of electrodes. However, in contrast to the use of such organic solvents, some of the slurries described herein may be prepared using water or other aqueous solutions (e.g., water containing salts, or the like), and/or other suitable hydrophilic solvents such as ethanol.

The slurry may be coated onto a current collector material, e.g., to form an electrode. Examples of current collector materials include, but are not limited to, aluminum, copper, silver, gold, platinum, titanium, nickel, chromium, iron, or the like, as well as combinations (e.g., alloys) of any of these and/or other suitable materials. The current collector may, in some cases, have a shape (e.g., a cylindrical shape) that can be used as an electrode within a battery or other electrochemical cell.

The slurry may be coated onto the current collector material using any suitable technique, e.g., by painting, laminating, soaking, spraying, casting, roll-to-roll pressing, etc. the current collector with the slurry. The slurry may be allowed to dry, e.g., passively (upon exposure to the ambient environment), and/or under conditions to facilitate drying, such as increased heat and/or decreased humidity. For example, the slurry may be exposed to relative humidities of less than 50%, less than 45%, less than 40%, less than 35%, less than 30%, less than 25%, less than 20%, less than 15%, less than 10%, or less than 5% water. In some cases, the humidity may be decreased by exposure to desiccants such as phosphorous pentoxide, calcium oxide, calcium sulfate, cobalt (II) chloride, silica gel, or the like. In certain embodiments, the slurry may be exposed to increased temperatures, e.g., temperatures of at least 40° C., at least 50° C., at least 60° C., at least 70° C., at least 80° C., at least 90° C., at least 100° C., at least 110° C., at least 120° C., at least 130° C., at least 140° C., at least 150° C., etc. Combinations of temperature and/or relative humidity and/or other suitable drying conditions (for example, increased airflow) may also be used in certain cases.

After sufficient drying, the slurry may form a suitable coating on the current collector material, e.g., suitable for use as an electrode in a battery or other electrochemical cell. In some cases, at least 50 wt %, at least 55 wt %, at least 60 wt %, at least 65 wt %, at least 70 wt %, at least 75 wt %, at least 80 wt %, at least 85 wt %, at least 90 wt %, or at least 95 wt % of the water may be removed from the initial slurry to prepare the electrode.

Thus, in some embodiments, a battery or other electrochemical cell may be produced using materials and methods such as those described herein. For example, a lithium-ion electrochemical cell may be prepared using a cathode comprising a positive electroactive material such as described herein, a negative electroactive material such as described herein, a suitable electrolyte (e.g., a non-aqueous electrolyte), and a separator between the negative electroactive material and the positive electroactive material. In some cases, a slurry as discussed herein may be used to prepare one or both of the electrodes for a battery or other electrochemical cell, e.g., a lithium-ion electrochemical cell or a sodium-ion electrochemical cell. In some cases, the electrodes may be free of any detectable amounts of N-methyl pyrrolidone (NMP) or other organic solvents.

Certain aspects of the invention are also generally directed to electrochemical cells prepared as discussed herein, for example, using slurries and/or methods of using such slurries as discussed herein. In some cases, the electrochemical cell may comprise positive and negative electrodes, electrolytes, separators, and the like.

For example, a variety of electrolytes may be used in various embodiments. The electrolyte may be aqueous or non-aqueous. Non-limiting examples of suitable non-aqueous electrolytes include lithium hexafluorophosphate (LiPF₆) in ethylene carbonate (EC) and dimethyl carbonate (DMC), lithium hexafluorophosphate (LiPF₆) in ethylene carbonate (EC) and diethyl carbonate (DEC), lithium bis(trifluoromethane sulfonyl)imide (LiTFSI)) in ethylene carbonate (EC) and dimethyl carbonate (DMC), lithium bis(trifluoromethane sulfonyl)imide in ethylene carbonate (EC) and diethyl carbonate (DEC), lithium hexafluorophosphate (LiPF₆) in ethylene carbonate (EC) and ethyl methyl carbonate (EMC), and/or lithium bis(trifluoromethane sulfonyl) imide (LiTFSI) imide in ethylene carbonate (EC) and ethyl methyl carbonate (EMC). Specific non-limiting examples of suitable non-aqueous electrolytes are 1 mol/L lithium hexafluorophosphate (LiPF₆) in ethylene carbonate (EC) and dimethyl carbonate (DMC), 1 mol/L lithium hexafluorophosphate (LiPF₆) in ethylene carbonate (EC) and diethyl carbonate (DEC), and 1 mol/L lithium hexafluorophosphate (LiPF₆) in ethylene carbonate (EC) and ethyl methyl carbonate (EMC).

A variety of separators can be used in various embodiments. Examples of separators include, but are not limited to, the Celgard 2400, 2500, 2340, and 2320 models.

The following are each incorporated herein by reference in its entirety: Int. Pat. Apl. Ser. No. PCT/US16/52627, filed Sep. 20, 2016, entitled “Nickel-Based Positive Electrode Materials”; U.S. Pat. Apl. Ser. No. 62/435,669, filed Dec. 16, 2016, entitled “Electroactive Materials for Lithium-Ion Batteries and Other Applications”; and U.S. Pat. Apl. Ser. No. 62/461,890, filed Feb. 22, 2017, entitled “Core-Shell Electroactive Materials.”

The following examples are intended to illustrate certain embodiments of the present invention, but do not exemplify the full scope of the invention.

### Example 1

A sample cathode electrode was prepared as follows: (i) 4 wt % poly(lithium acrylate) (PLA) was dissolved in distilled water to form an ionomer aqueous solution; (ii) 6 wt % poly(vinylidene fluoride-hexafluoropropylene) (PVDF-HFP) binder was mixed in the ionomer aqueous solution to form an ionomer-binder aqueous solution; (iii) the ionomer-binder aqueous solution was mixed with the positive electroactive material lithium iron phosphate (“LFP”) and carbon black to form a mixture containing 75 wt % positive electroactive material, 15 wt % carbon black, 4 wt % PLA and 6 wt % PVDF-HFP (“the 75:15:4:6 mixture”); (iv) the 75:15:4:6 mixture was transferred into a ball mill, and the mixture milled at 600 rpm for 45 min with ten 5 mm diameter zirconia balls to form a slurry, where the zirconia balls function as a medium to facilitate mixing; (v) a current collector was prepared by spreading aluminum foil onto a glass plate and spraying acetone to prevent the formation of air bubbles between the foil and the glass plate; (vi) the slurry was uniformly spread onto the aluminum foil using a razor blade to form a coating film; and (vii) the coating was dried in a vacuum at 55° C. for 3 hours then at 110° C. for 12 hours to form the cathode electrode.

### Example 2

By combining a lithium intercalation negative electroactive material, a carbonate non-aqueous electrolyte, a separator, and the positive electroactive material described in Example 1, a distinct lithium-ion electrochemical cell was prepared in this example.

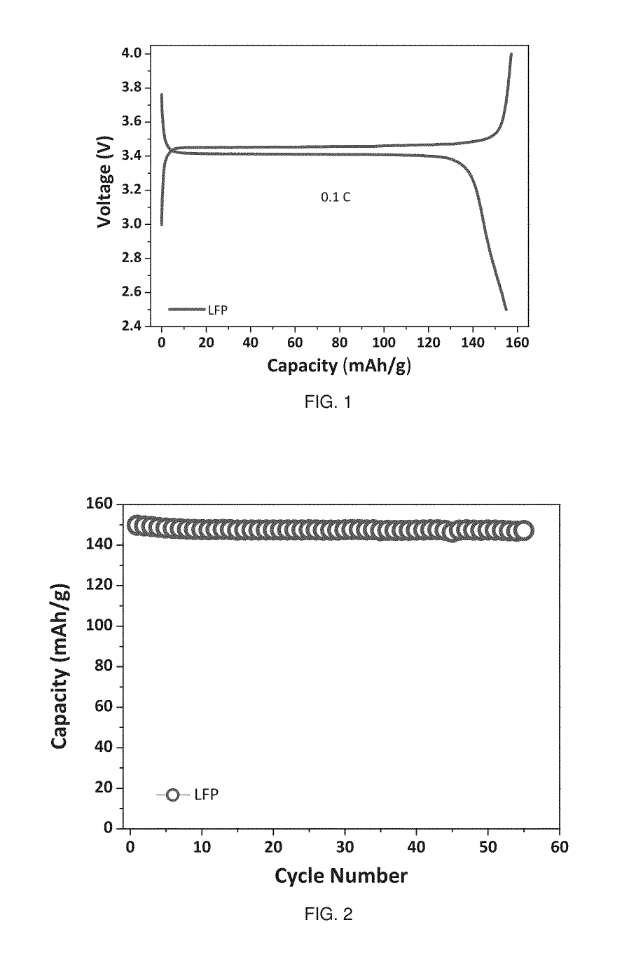

A BT-2000 Arbin battery test station (Arbin Instruments) was used to charge and discharge each cell between +4.0 V and +2.5 V at room temperature with 0.1 C current rate. FIG. 1 is a plot of the first cycle voltage versus capacity for the electrochemical cell prepared with the positive electroactive material of Example 1. In FIG. 1, the upward-sloping curve is the charging curve, showing that the cell was charged to +4.0 V; it represents the charge capacity vs. voltage. The downward-sloping curve is the discharging curve, showing that the cell was then discharged to +2.5 V; it represents the discharge capacity vs. voltage. It exhibits the discharge capacity was 155.0 mAh/g. FIG. 1 is a plot of the first cycle voltage vs capacity for the electrochemical cell prepared with this material. FIG. 2 illustrates discharge capacity versus cycle number for the electrochemical cell prepared with the positive electroactive material of Example 1. One cycle represents a full charge and discharge cycle of the cell. FIG. 2 shows the capacity retention versus the first cycling was 98.2% after fifty-five cycles.

### Example 3

A cathode electrode was prepared as follows: (i) 5 wt % poly(sodium vinylsulfonate) (PSVS) was dissolved in distilled water to form an ionomer aqueous solution; (ii) an equivalent amount of polyvinylidene fluoride (PVDF) binder was mixed in the ionomer aqueous solution to form an ionomer-binder aqueous solution; (iii) the ionomer-binder aqueous solution was mixed with the positive electroactive material lithium nickel manganese cobalt oxide and carbon black to form a mixture containing 80 wt % positive electroactive material, 10 wt % carbon black, 5 wt % PSVS and 5 wt % PVDF (“the 80:10:5:5 mixture”); (iv) the 85:10:5:5 mixture was transferred a ball mill, and the mixture milled at 800 rpm for 30 minutes with ten 5 mm diameter zirconia balls to form a slurry, where the zirconia balls function as a medium to facilitate mixing; (v) a current collector was prepared by spreading aluminum foil onto a glass plate and spraying with acetone to prevent the formation of air bubbles between the foil and the glass plate; (vi) the slurry was uniformly spread onto the aluminum foil using a razor blade to form a coating film; and (vii) the coating was dried in a vacuum at 55° C. for 2 hours and then at 110° C. for 12 hours to form the cathode electrode.

### Example 4

An anode electrode was prepared as follows: (i) 12 wt % poly(lithium acrylate) (PLA) was dissolved in distilled water to form an ionomer aqueous solution; (ii) 4 wt % polyvinylidene fluoride (PVDF) binder was mixed in the ionomer aqueous solution to form an ionomer-binder aqueous solution; (iii) the ionomer-binder aqueous solution was mixed with the negative electroactive material lithium titanate and carbon black to form a mixture containing 80 wt % negative electroactive material, 4 wt % carbon black, 12 wt % PLA and 4 wt % PVDF (“the 80:4:12:4 mixture”); (iv) the 80:4:12:4 mixture was transferred into a ball mill, and the mixture milled at 700 rpm for 45 min with ten 5 mm diameter zirconia balls to form a slurry, where the zirconia balls function as a medium to facilitate mixing; (v) a current collector was prepared by spreading copper foil onto a glass plate and spraying with acetone to prevent the formation of air bubbles between the foil and the glass plate; (vi) the slurry was uniformly spread onto the foil using a razor blade to form a coating film; and (vii) the coating was dried in a vacuum at 55° C. for 3 hours then at 100° C. for 12 hours to form the anode electrode.

### Example 5

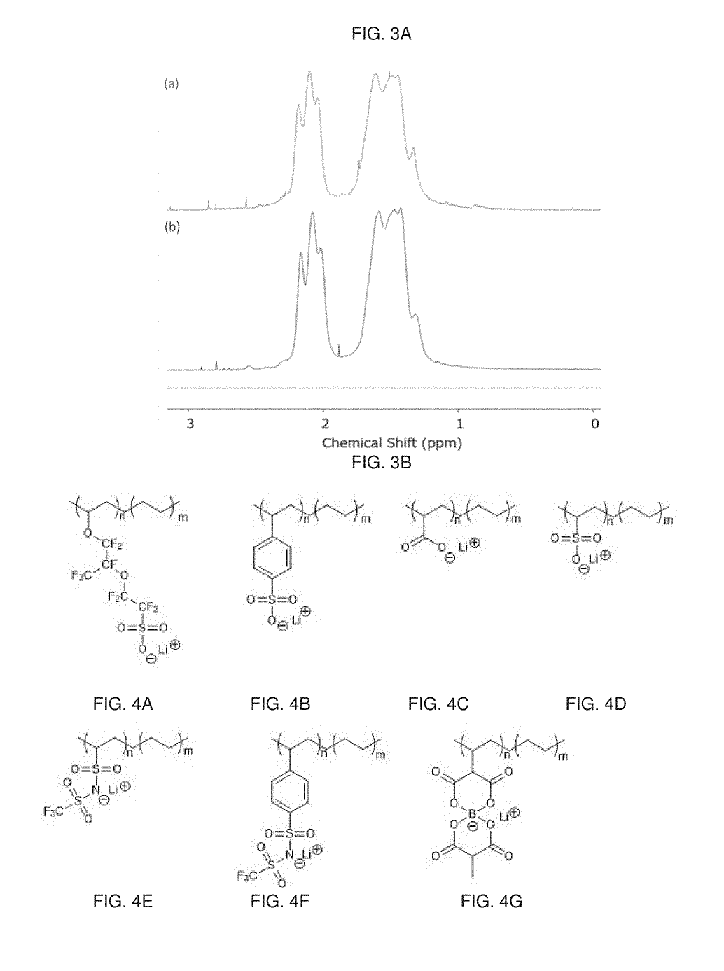

The cathode powders were moved from the electrode prepared in Example 1 into a small vial. The powders were suspended in deuterium oxide (D₂O). After filtration, the solution was measured in nuclear magnetic resonance (NMR) spectroscopy. FIG. 3A shows the NMR spectra of poly(lithium acrylate) PLA obtained in the cathode electrode, which is consistent with that of pure PLA (FIG. 3B), which confirms that PLA was present in the electrode, and could not be removed during the electrode manufacturing process. A Brucker Advance NMR spectrometer was used for the NMR analysis, at 500 MHz for proton NMR. Measurements were performed at 23.5° C. under atmospheric pressure. The sample was spun at 20 rpm/s. Deuterated water was used to dissolve the sample and for signaling the locking field. The proton NMR used a 45° polarized pulse with 2 to 1024 scans, depending on the concentration of corresponding sample solution.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the invention includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A composition, comprising:
an aqueous slurry comprising less than 50 wt % of an ionomer, less than 50 wt % of a binder and a conductive additive, and an electroactive material.

2. The composition of claim 1, wherein the aqueous slurry consists essentially of the ionomer, the binder, the conductive additive, the electroactive material, and water.

3. The composition of claim 1, wherein the weight percentages of the ionomer, the binder, the conductive, and the electroactive material in the aqueous slurry sum to between 90 wt % and 100 wt %.

4-5. (canceled)

6. The composition of claim 1, wherein the ionomer comprises a backbone group, an anionic substituent, and a cation.

7-12. (canceled)

13. The composition of claim 6, wherein the backbone group comprises styrene and/or ethylene and/or propylene and/or acrylate and/or methacrylate and/or butadiene and/or vinylidene difluoride and/or tetrafluoroethylene.

14-20. (canceled)

21. The composition of claim 6, wherein the anionic substituent comprises carboxylate and/or alkyl carboxylate and/or perfluoroalkyl carboxylate and/or thioglycolate and/or phosphonate and/or sulfonate and/or benzenesulfonate and/or tartrate.

22-28. (canceled)

29. The composition of claim 1, wherein the cation comprises sodium and/or potassium and/or lithium and/or magnesium and/or calcium and/or aluminum and/or zinc and/or iron and/or copper and/or silver and/or cobalt and/or mercury and/or nickel and/or chromium.

30-42. (canceled)

43. The composition of claim 1, wherein the binder comprises polyvinylidene fluoride and/or poly-o-methoxyaniline and/or polytetrafluoroethylene and/or poly(vinylidene fluoride-hexafluoropropylene) and/or polyethylene oxide (PEO) poly(3,4-ethylenedioxythiophene) polystyrene sulfonate.

44-47. (canceled)

48. The composition of claim 1, wherein the conductive additive comprises carbon black and/or poly(3,4-ethylenedioxythiophene) polystyrene sulfonate and/or carbon nanotubes and/or carbon nanofibers and/or polypyrrole and/or graphene and/or graphene oxide.

49-54. (canceled)

55. The composition of claim 1, wherein the electroactive material comprises graphite.

56. The composition of claim 1, wherein the electroactive material comprises lithium titanate and/or metallic lithium and/or lithium metal oxide and/or lithium manganese oxide and/or lithium nickel cobalt aluminum oxide and/or lithium cobalt oxide and/or lithium nickel cobalt manganese oxide and/or lithium iron phosphate.

57-63. (canceled)

64. The composition of claim 1, wherein the aqueous slurry is free of organic solvent.

65. A method of making an electrode for use in an electrochemical cell, the method comprising:
applying, to a current collector material, an aqueous slurry comprising less than 50 wt % of an ionomer, less than 50 wt % of a binder and a conductive additive, and an electroactive material; and
removing at least some water from the aqueous slurry to produce a dried coating on the current collector material, thereby forming an electrode.

66. (canceled)

67. The method of claim 65, comprising removing at least some water from the aqueous slurry via evaporation.

68. The method of claim 65, comprising removing at least 90 wt % of the water from the aqueous slurry.

69. The method of claim 65, comprising removing at least some of water from the aqueous slurry by exposing the aqueous slurry applied to the current collector material to a temperature of at least 40° C.

70-74. (canceled)

75. The method of claim 65, wherein the ionomer comprises a backbone group, an anionic substituent, and a cation.

76. The method of claim 65, wherein the aqueous slurry is free of organic solvent.

77. An electrochemical device, comprising an electrode formed using the method of claim 65.

78. The electrochemical device of claim 77, wherein the electrode is substantially free of organic solvent.
